(19) United States
(12) Patent Application Publication
(10) Pub. No.: US 2009/0024310 A1
(43) Pub. Date: Jan. 22, 2009

(54) Device for Estimating the Position of the Center of Gravity of a Vehicle

(75) Inventors: Sven Karrie, Kirchheim (DE); Christian Kobetz, Esslingen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/791,028

(22) PCT Filed: Nov. 12, 2005
(86) PCT No.: PCT/EP05/12146

§ 371 Date: May 9, 2008

(30) Foreign Application Priority Data
Nov. 19, 2004 (DE) 10 2004 055 856.6

(51) Int. Cl. G06F 17/10

(52) U.S. Cl. 701/124

(57) ABSTRACT

A device and a method for estimating the position of the center of gravity of a vehicle are described. A sensing device which determines a weightload variable which indicates a weightload, and an evaluation unit which, on the basis of the acquired weightload variable, determines a center of gravity position variable which represents the position of the center of gravity of the vehicle are provided. The sensing device is arranged in the spatial vicinity of an additional load which can be mounted in the roof region of the vehicle, wherein the evaluation unit determines the center of gravity position variable on the basis of the weightload variable which indicates the additional load.

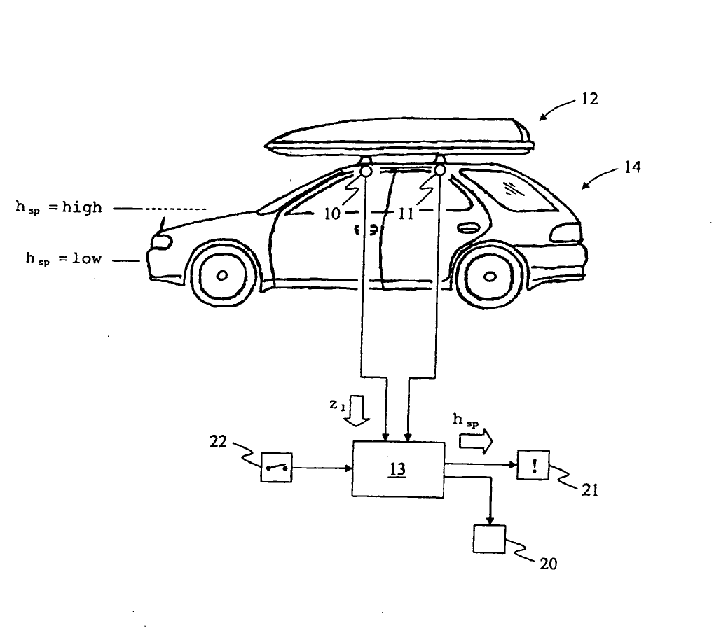

### CROSS REFERENCE TO RELATED APPLICATIONS

This application is a national stage of PCT International Application No. PCT/EP2005/012146 filed Nov. 12, 2005, which claims priority under 35 U.S.C. § 119 to Germany Patent Application No. 10 2004 055 856.6 filed Nov. 19, 2004, the entire disclosures of which are herein expressly incorporated by reference.

### BACKGROUND AND SUMMARY OF THE INVENTION

The invention relates to a device for estimating the position of the center of gravity of a vehicle, in which a sensing device determines a weightload variable that indicates a weightload. Based on the acquired weightload variable, an evaluation unit determines a center of gravity position variable which represents the position of the center of gravity of the vehicle.

A conventional device for determining the position of the center of gravity of a vehicle is found in German Patent document DE 37 11 239 C2. The known device has a load measuring component which is composed of at least three pressure measuring devices and/or strain measuring devices which are mounted on the chassis of the vehicle near to a support point where it is supported on the underlying surface. Since the weight forces which occur at each of the support points are each different, depending on the location of the loads acting on the vehicle, it is possible to infer the instantaneous center of gravity of the vehicle directly by evaluating the measured values acquired by the load measuring device. Owing to the selected spatial arrangement of the load measuring device, it bears virtually the entire weight of the vehicle. The resulting increased requirements made on the load bearing capacity of the pressure measuring devices and/or strain measuring devices used result in correspondingly high equipment costs, which permit use of the known device mainly in the field of commercial utility vehicles but not, for example, in the field of passenger cars, which is significantly more cost sensitive.

The present invention provides a device as described above that permits the position of the center of gravity of the vehicle to be estimated in a way which is cost-effective and sufficiently precise for most applications.

According to an exemplary embodiment, the invention includes a device for estimating the position of the center of gravity of a vehicle which has, in addition to a sensing device which determines a weightload variable which indicates a weightload, also an evaluation unit which, on the basis of the acquired weightload variable, determines a center of gravity position variable which represents the position of the center of gravity of the vehicle.

Exemplary embodiments of the invention may be based on the recognition that an additional load which is localized in the vicinity of the bottom of the vehicle, for example in the form of vehicle occupants or baggage located in the cargo space or trunk of the vehicle, gives rise to significantly smaller effects on the position of the center of gravity of the vehicle than an additional load of comparable weight which is positioned in the roof region of the vehicle. This applies in particular in the case of vehicles with an increased overall height, typically including offroad vehicles, minibuses, station wagons, vans and the like. For most applications it is therefore sufficient if, for the purpose of estimating the position of the center of gravity, essentially only the additional load which is, or can be, positioned in the roof region of the vehicle is taken into account instead of the entire weight of the vehicle. According to embodiments of the invention this is achieved with the sensing device being arranged in the spatial vicinity of the additional load which is, or can be, positioned in the roof region of the vehicle. The center of gravity position variable is then determined on the basis of the weightload variable which indicates the additional load. This procedure requires a comparatively low load bearing capacity of the sensing device which is used so that it is possible to implement a cost-effective alternative for estimating the position of the center of gravity of the vehicle.

Advantageous embodiments of the device according to the invention will be described in the following text.

Since the instantaneous level of the center of gravity of the vehicle has a considerable influence on the transverse dynamics behavior of the vehicle in the case of transverse accelerations which act on the vehicle, such as when traveling through a bend, and carrying out an avoidance maneuver, in the case of an inclined underlying surface or due to cross wind influences, it is advantageous, in particular for the purpose of assessing the transverse stability of the vehicle, if the center of gravity position variable represents the position of the center of gravity in the vertical direction with respect to the underlying surface. In this context, the center of gravity position variable can be a distance variable which describes the absolute or relative position of the center of gravity of the vehicle in the vertical direction with respect to the underlying surface.

Particularly precise estimation of the position of the center of gravity is possible if the sensing device is a sensor device which is sensitive to the weightload. The weightload sensitive sensor device may include, for example, at least one strain gauge which is provided for measuring the weight or the weight distribution of the additional load. The functional principle of such a strain gauge is sufficiently known from the specialized literature and will not be explained in more detail at this point. The weight position variable is then present in the form of a resistance signal which changes with the weight or with the weight distribution of the additional load, and which permits precise estimation of the center of gravity of the vehicle both in the vertical and horizontal directions with respect to the underlying surface.

In addition or alternatively, the sensing device can also be embodied in the form of a simple switching device which unambiguously changes its switched state when the additional load or a roof load carrier provided for holding the additional load is applied. Such a roof load carrier, usually also referred to as a roof rack, serves, for example, for securely attaching a roof box, ski holders, cycle holders, or any other roof loads.

The switching device may be either a load switch which changes its switched state when a specific triggering force is exceeded or undershot, or else an electromechanical or electronic switch which switches in a load-free fashion, for example a contact path which is closed when the additional load or the roof load carrier is applied, a safety switch which is activated when a roof cover of a mounting opening which is provided for attaching the roof load carrier is opened manually, a reed switch or a radio-controlled switch. The latter can comprise an active or passive short-range transponder assigned to the additional load and a receiver device which is arranged in the roof region of the vehicle. If the receiver device detects the presence of the transponder and thus of the additional load in the roof region of the vehicle, a corresponding switching signal is generated.

In the case of the exemplary switching devices described above, the weightload variable is typically present in the form of an easy to evaluate, binary switched-state which indicates directly whether the additional load or the roof load carrier is present or not.

Which of the sensing devices specified above is ultimately used may depend both on the respective application and the acceptable expenditure, and particularly also on the degree of precision which is to be achieved in the context of the determination of the center of gravity position variable.

In order to ensure reliable sensing of the additional load or of the roof load carrier, the sensing device is arranged as far as possible in the spatial vicinity of the additional load or of the roof load carrier, that is to say directly in the roof region of the vehicle. Correspondingly it is advantageous if the sensing device is arranged, for example, in the side region of a roof frame of the vehicle and/or in the roof region of one of the vehicle body pillars of the vehicle. In addition or alternatively it is possible for the sensing device to be assigned to the roof load carrier, in which case the signals of the sensing device are preferably transmitted in a wireless signal fashion to the evaluation unit. The associated reduction in the expenditure on wiring simultaneously permits particularly easy retrofitting of the device according to the invention.

Furthermore it is possible in one embodiment for the center of gravity position variable to be determined before the journey starts, that is to say when the vehicle is in a stationary state. In this case vehicle movement dynamics effects in the form of interference forces which vary over time are prevented from acting on the sensing device and thus causing an incorrect weightload variable to be acquired. Such interference forces typically occur when the vehicle is accelerated or decelerated, when it is traveling through a bend, when it is carrying out an avoidance maneuver, in the case of an inclined underlying surface or due to side wind influences.

For many exemplary applications it is sufficient to determine the center of gravity position variable in accordance with predefined classification stages, as a result of which the computational capacity which is necessary to estimate the center of gravity which ultimately has to be made available by the evaluation unit can be reduced to a necessary minimum. If the center of gravity position variable represents the position of the center of gravity of the vehicle in the vertical direction with respect to the underlying surface, the classification can be carried out in accordance with linguistic states such as “low” or “high”.

The center of gravity position variable may be advantageously used to adapt the triggering characteristic of a driver assistance system which is arranged in the vehicle and/or to parameterize a vehicle model on which the driver assistance system is based, for example when the driver assistance system is a system for regulating the yaw rate of the vehicle, that is to say for example an electronic stability program (ESP).

The electronic stability program may serve to prevent or reduce transverse dynamics instabilities of the vehicle by virtue of the fact that when a triggering condition which determines the triggering characteristic of the electronic stability program is met, measures which stabilize the vehicle are carried out in accordance with the vehicle model on which the electronic stability program is based. Since the instantaneous position of the center of gravity of the vehicle has a considerable influence on the transverse dynamics behavior of the vehicle, it is possible, by using an appropriate adaptation of the triggering characteristic of the electronic stability program, performed as a function of the center of gravity position variable, or by using appropriate parameterization performed by the center of gravity position variable of the vehicle model on which the electronic stability program is based, to ensure that the countermeasures which stabilize the vehicle are triggered or carried out in a way which is reliable and appropriate for the situation irrespective of the instantaneous height of the center of gravity of the vehicle.

Other objects, advantages and novel features of the present invention will become apparent from the following detailed description of the invention when considered in conjunction with the accompanying drawings.

### BRIEF DESCRIPTION OF THE DRAWING

The device according to the invention will be explained in more detail below with reference to the appended drawing, in which the single FIGURE shows a schematically illustrated exemplary embodiment of the device according to an embodiment of the invention for estimating the position of the center of gravity of a vehicle.

### DETAILED DESCRIPTION OF THE DRAWING

The device has both a sensing device or devices 10, 11 which acquires a weightload variable z₁ which indicates a weightload, and also an evaluation unit 13 which, on the basis of the acquired weightload variable z₁, determines a center of gravity position variable hₛₚ which represents the position of the center of gravity of the vehicle 14. The sensing devices 10, 11 is arranged in this embodiment in the spatial vicinity of an additional load 12 which can be positioned on a top portion, such as the roof region of the vehicle 14, with the center of gravity position variable hₛₚ being determined on the basis of the weightload variable z₁ which indicates the additional load 12. As a result of the particular spatial arrangement of the sensing devices 10, 11, substantially only the additional load 12 which is positioned or can be positioned in the roof region of the vehicle 14 is taken into account in the estimation of the position of the center of gravity of the vehicle 14. According to the example, the additional load 12 is formed by a roof box which is mounted on a roof load carrier. In other embodiments, it is possible to provide a ski holder or cycle holder or any other roof load instead of the roof box.

The center of gravity position variable hₛₚ is intended to represent below the position of the center of gravity of the vehicle in the vertical direction with respect to the underlying surface, without restricting the generality of the system. The center of gravity position variable hₛₚ is determined in the present exemplary embodiment in accordance with predefined classification stages which each represent the instantaneous height of the center of gravity of the vehicle, in the form of discrete states.

The sensing device 10, 11 may be a weightload sensitive sensor device which comprises at least one strain gauge which is provided for measuring the weight of the additional load 12. The weightload variable z₁ is present in this case in the form of a resistance signal which changes with the weight of the additional load 12 and which is fed to the evaluation unit 13 in order to determine the center of gravity position variable hₛₚ. The exemplary evaluation unit 13 determines, by evaluating the resistance signal, that the weight of the additional load 12 is higher than a threshold value which is characteristic of decisive raising of the center of gravity of the vehicle, the center of gravity position variable hₛₚ thus assumes the state “high”. Otherwise, it is assumed that there is, in the best case, an insignificant raising of the center of gravity of the vehicle and the center of gravity position variable hip correspondingly assumes the complementary state “low”.

In one example, a decisive raising of the center of gravity of the vehicle occurs if the weight of the additional load 12 reaches a value between 50 and 100 kg g—the variable g designates here the gravitational acceleration—with an upper value being given by the maximum permissible roof load. The precise value at which decisive raising of the center of gravity of the vehicle occurs depends ultimately on the geometry of the vehicle, in particular on the height of the vehicle, and the height of the center of gravity of the vehicle which the vehicle 14 has in the unloaded state.

Instead of the illustrated exemplary two-stage determination of the center of gravity position variable hₛₚ, any desired finer or even continuous gradation of the states may be envisioned, for example in the form of corresponding fuzzy states or fuzzy partitioning.

In addition or alternatively, the sensing device 10, 11 may be embodied in the form of a switching device which unambiguously changes its switched state when the additional load 12, or the roof load carrier which is provided to hold the additional load 12, is positioned.

The switching device may either be a load switch, which changes its switched state when a specific triggering force is exceeded or undershot, or else an electromechanical or electronic switch, for example a contact path, which switches in a load-free fashion and is closed when the additional load 12 or the roof load carrier is positioned. A safety switch may be activated when a protective cover of a mounting opening which is provided for attaching the roof load carrier is opened manually, a reed switch or a radio controlled switch may also be provided. The weightload variable z₁ is then present in the form of a binary switched-state which indicates directly the presence of the additional load 12 or of the roof load carrier, and thus the actual or potential presence of a decisive raising of the center of gravity of the vehicle. The switched-state of the switching device is fed to the evaluation unit 13. If the evaluation unit 13 determines, by evaluating the switched-state, that the switching device has a switched state which indicates the presence of the additional load 12 or of the roof load carrier, the center of gravity position variable hₛₚ assumes the state “high”. Otherwise, it is inferred that there is neither an additional load 12 nor a roof load carrier present, and the center of gravity position variable hₛₚ accordingly assumes the complementary state “low”.

In order to ensure reliable sensing of the additional load 12 or of the roof load carrier which is provided for holding the additional load 12, the exemplary sensing device 10, 11 is arranged as far as possible in the vicinity of the additional load 12 or of the roof load carrier, for example in the side region of a roof frame of the vehicle 14 or in the roof region of one of the vehicle body pillars of the vehicle 14. In addition or alternatively, the sensing device 10, 11 is assigned to the roof load carrier, with the signals of the sensing device 10, 11 being transmitted in this case in a wireless signal fashion to the evaluation unit 13.

The center of gravity position variable hₛₚ may be determined in each case before the journey starts, as a baseline value that is to say when the vehicle 14 is in a stationary state, for example directly when the additional load 12 or the roof load carrier is positioned. In this case, vehicle movement dynamics effects in the form of interference forces which vary over time are prevented from acting on the sensing device 10, 11 and thus from causing an incorrect value to be acquired for the weightload variable z₁ which is used to determine the center of gravity position variable hₛₚ. Such interference forces occur typically when the vehicle 14 is accelerating or decelerating, when traveling through a bend, when carrying out an avoidance maneuver, in the case of an inclined underlying surface or due to side wind influences.

The center of gravity position variable hₛₚ which is determined in this way may be used, inter alia, to adapt the triggering characteristic of a driver assistance system 20 which is arranged in the vehicle 14 and/or to parameterize a vehicle model on which the driver assistance system 20 is based, the driver assistance system 20 being a system for regulating the yaw rate of the vehicle 14, an electronic stability program (ESP) in the present case.

The exemplary electronic stability program serves here to prevent or reduce transverse dynamics instabilities of the vehicle 14 by virtue of the fact that measures which stabilize the vehicle are carried out in accordance with a vehicle model on which the electronic stability program is based if a triggering condition which determines the triggering characteristic of the electronic stability program is met. Since raising of the center of gravity has considerable effects on the transverse dynamics behavior of the vehicle 14, the triggering characteristic of the electronic stability program is adapted as a function of the center of gravity position variable hₛₚ, or the vehicle model on which the electronic stability program is based is parameterized by the center of gravity position variable hₛₚ, in such a way that it is ensured that the measures which stabilize the vehicle are triggered or carried out in a way which is reliable and appropriate for the situation irrespective of the instantaneous height of the center of gravity of the vehicle.

In order to make the driver aware of the presence of a raised center of gravity of the vehicle, a signal transmitter unit 21 which is provided for outputting a visual and/or acoustic driver indication is actuated as a function of the center of gravity position variable hₛₚ, with the driver information being output only if decisive raising of the center of gravity of the vehicle is inferred, that is to say if the center of gravity position variable hₛₚ has the state “high”.

If it is impossible to carry out a determination of the instantaneous center of gravity position variable, for example due to incompatibilities between the roof load carrier (other make or the like) provided to hold the additional load 12 and the sensing device 10, 11, it is possible for the driver to set the state of said center of gravity position variable (“high” or “low”) manually on an operator control 22 which may be i arranged in the vehicle 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. A device for estimating a position of a center of gravity of a vehicle, comprising:
a sensing device which determines a weightload variable which indicates a weightload; and
an evaluation unit which, on the basis of the acquired weightload variable, determines a center of gravity position variable which represents the position of the center of gravity of the vehicle; wherein,
the sensing device is arranged in spatial proximity to an additional load mountable on a roof region of the vehicle; and
the evaluation unit determines the center of gravity position variable on the basis of the weightload variable which indicates the additional load.

10. The device as claimed in claim 9, wherein the center of gravity position variable represents the position of the center of gravity of the vehicle in a vertical direction with respect to an underlying surface.

11. The device as claimed in claim 9, wherein the sensing device comprises a sensor device which is sensitive to one of the weightload and a switching device.

12. The device as claimed in claim 9, wherein the sensing device is arranged in one of a side region of a roof frame of the vehicle and in the roof region of a vehicle body pillar of the vehicle.

13. The device as claimed in claim 9, wherein the sensing device is assigned to a roof load carrier mountable in the roof region of the vehicle

14. The device as claimed in claim 9, wherein the center of gravity position variable is determined before a journey starts.

15. The device as claimed in claim 9, wherein the center of gravity position variable is determined in accordance with predefined classification stages.

16. The device as claimed in claim 9, wherein the center of gravity position variable is used to adapt a triggering characteristic of a driver assistance system which is arranged in the vehicle.

17. The device as claimed in claim 9, wherein,
the center of gravity position variable is used to parameterize a vehicle model on which a driver assistance system is based; and
the driver assistance system comprises a system for regulating the yaw rate of the vehicle.

18. A driver assistance system for a vehicle, comprising:
a load carrying element for receiving an additional load on a top portion of the vehicle;
a sensing device for determining a weightload variable reflecting a weight due to the additional load disposed on the load carrying element, the sensing device being spatially proximate to the additional load; and
an evaluation unit receiving the weightload variable and determining therefrom a center of gravity position variable related to a position of a center of gravity of the vehicle.

19. The system according to claim 18, wherein the evaluation unit determines values of the center of gravity position variable corresponding to selected ranges of the weightload variable.

20. The system according to claim 19, wherein the center of gravity position variable comprises a low value corresponding to a weightload variable below a threshold value, and a high value corresponding to a weightload variable above a threshold value.

21. The system according to claim 18, wherein the sensing device comprises a weight sensitive switch.

22. The system according to claim 18, wherein the sensing device is disposed within a roof support structure of the vehicle.

23. The system according to claim 18, wherein the sensing device is disposed in a roof rack attached to the vehicle.

24. The system according to claim 21, wherein the evaluation unit determines a high value of the center of gravity position variable in response to a signal of the weight sensitive switch indicating presence of the additional load.

25. The system according to claim 18, wherein the evaluation unit determines a baseline value of the center of gravity position variable in an unaccelerated state.

26. A method of providing a driver assistance system for a vehicle, comprising the acts of:
sensing a weightload variable in a sensing device disposed spatially proximate to an additional load on a top portion of the vehicle;
determining in an evaluation unit a center of gravity position variable related to the center of gravity based on the sensed weightload variable; and
adapting a driver assistance system in response to the center of gravity position variable.

27. The method according to claim 26, further comprising determining a high value and a low value of the center of gravity position variable based on the sensing device indicating that the additional load is respectively present and absent.

28. The method according to claim 26, further comprising determining a high value and a low value of the center of gravity position variable based on weightload variable being respectively above and below a threshold value.
